(19) United States
(12) Patent Application Publication
(10) Pub. No.: US 2018/0063547 A1
(43) Pub. Date: Mar. 1, 2018

(54) MOTION VECTOR DETECTION APPARATUS AND METHOD FOR CONTROLLING THE SAME

(71) Applicant: CANON KABUSHIKI KAISHA, Tokyo (JP)

(72) Inventor: Yukifumi Kobayashi, Tokyo (JP)

(21) Appl. No.: 15/679,881

(22) Filed: Aug. 17, 2017

(30) Foreign Application Priority Data
Aug. 23, 2016 (JP) 2016-163037

(51) Int. Cl. H04N 19/57; H04N 19/51; G06T 7/223; H04N 5/14

(52) U.S. Cl. CPC H04N 19/57; H04N 19/51; G06T 2207/10016; H04N 5/145; G06T 7/223

(57) ABSTRACT

A motion vector detection apparatus stores data of a target block with respect to which a motion vector is detected among a plurality of blocks contained in a coding target picture, stores data of a search range for searching for a region in a reference picture to be used to detect the motion vector with respect to the target block and detects the motion vector of the target block based on the region similar to the target block that is searched for in the data of the search range.

### BACKGROUND OF THE INVENTION

### Field of the Invention

The present invention relates to a motion vector detection apparatus and a method for controlling the motion vector detection apparatus.

### Description of the Related Art

Conventionally, there has been known motion compensation inter-frame prediction as a method for efficiently reducing a code quantity of a moving image. In the motion compensation inter-frame prediction, a code quantity of a coding target picture is reduced by predicting a motion vector with use of a reference picture, and coding a difference vector thereof. Further, the motion vector is also used for an image shake correction of an imaging apparatus, prediction of a motion of an object, an image composition, and the like.

Generally, the motion vector is detected block by block, by using each of blocks into which the coding target picture is divided as a template image, and searching for a region having a highest correlation with the template image in a search range, which is a part of the reference picture (template matching). For example, a region around a position in the reference picture that corresponds to the block used as the template image is set as the search range.

Widening the search range allows even a movement destination of a large motion to be contained in the search range, thereby contributing to improvement of accuracy with which the motion vector is detected but causing an increase in a processing load regarding the search. On the other hand, narrowing the search range contributes to a reduction in the processing load regarding the search, but risking a failure to contain a region that should be searched for (the movement destination) in the search range and thus causing deterioration of the accuracy with which the motion vector is detected. The failure to contain the movement destination in the search range undesirably leads to a failure to detect the motion vector or detection of an incorrect motion vector, thereby causing reductions in coding efficiency and an image quality.

In this manner, the size of the search range is an important element affecting the processing load and the accuracy relating the motion vector detection, and is required to be appropriately set. For example, Japanese Patent Application Laid-Open No. 2008-236015 proposes that the search range is changed according to an imaging scene.

Now, in a case where the motion vector detection is carried out by hardware processing, data of the search range from among the data of the reference picture stored in an external memory is read into an internal memory, and this data is used in a calculation of the correlation with a target block (template image) with respect to which the motion vector is detected.

The search range is set target-block by target-block, but, for example, search ranges set to adjacent blocks contain portions overlapping with each other. Therefore, reading the data of the search range into the internal memory every time the target block is changed leads to repeatedly reading in the portion overlapping with another search range, thereby resulting in a reduction in use efficiency of a bandwidth of a bus and power.

Then, one conceivable measure against it is to read a plurality of search ranges into the internal memory at one time in advance. For example, suppose that the size of the search range is the same among all target blocks, and is m pixels in a horizontal direction and n pixels in a vertical direction. In this case, a plurality of search ranges located at different positions in the horizontal direction can be read into the internal memory at one time by conducting the read-in so as to read in horizontal pixel lines in the reference picture as many as n lines.

However, in this case, if the number of pixels in the horizontal direction in the reference picture is increased, a data amount corresponding to the horizontal pixel lines as many as n lines is also increased. Therefore, a storage capacity of the internal memory may become insufficient. Further, it is also possible to increase the capacity of the internal memory in advance, but all of a scale of a circuit, power consumption, and cost are increased.

On the other hand, reducing the number of lines to be read in results in an undesirable reduction in the vertical size of the search range, thereby raising a possibility of deterioration of accuracy with which the motion vector is searched for in the vertical direction.

There is a need in the art for a technique that allows the data of the search range in the reference picture to be efficiently read out and also preventing or reducing the deterioration of the accuracy with which the motion vector is detected, even when the number of pixels in the reference picture is large.

### SUMMARY OF THE INVENTION

According to an aspect of the present invention, a motion vector detection apparatus includes a first storage unit configured to store data of a target block with respect to which a motion vector is detected among a plurality of blocks contained in a coding target picture, a second storage unit configured to store data of a search range for searching for a region in a reference picture to be used to detect the motion vector with respect to the target block, a detection unit configured to detect the motion vector of the target block based on the region similar to the target block that is searched for in the data of the search range, and a control unit configured to perform control so as to store data of a first search range in the second storage unit in such a manner that the motion vector with respect to the target block that is contained in the region is detected in a predetermined order while the coding target picture is handled as one region if the number of pixels in a horizontal direction in the coding target picture is smaller than a predetermined value, and store data of a second search range in the second storage unit in such a manner that the motion vector with respect to the target block that is contained in the region is detected in the predetermined order separately for each of a plurality of regions having a smaller number of pixels in the horizontal direction than the number of pixels in the horizontal direction in the coding target picture if the number of pixels in the horizontal direction in the coding target picture is larger than the predetermined value.

Further features of the present invention will become apparent from the following description of exemplary embodiments with reference to the attached drawings.

### BRIEF DESCRIPTION OF THE DRAWINGS

FIG. 1 is a block diagram illustrating an example of a functional configuration of a digital camera using a motion vector detection apparatus according to an exemplary embodiment of the present invention.

FIGS. 2A and 2B illustrate examples of a target block and a search range according to the exemplary embodiment.

FIGS. 3A and 3B illustrate examples of the target block and the search range according to the exemplary embodiment.

FIGS. 4A and 4B illustrate examples of the target block and the search range according to the exemplary embodiment.

FIGS. 5A and 5B illustrate examples of tiles and the search range set in the exemplary embodiment.

FIGS. 6A and 6B illustrate examples of the target block and the search range according to the exemplary embodiment.

FIGS. 7A and 7B illustrate examples of the tiles and the search range set in the exemplary embodiment.

FIGS. 8A and 8B illustrate examples of the target block and the search range according to the exemplary embodiment.

FIG. 9 is a flowchart regarding processing for detecting a motion vector according to the exemplary embodiment.

### DESCRIPTION OF THE EMBODIMENTS

In the following description, a representative exemplary embodiment of the present invention will be described in detail with reference to the drawings. In the exemplary embodiment that will be described below, a digital camera will be described as one example of an electronic apparatus to which a motion vector detection apparatus according to the present invention is applicable. However, a configuration for capturing and/or recording a moving image is not essential to the present invention. The present invention is applicable to any electronic apparatus capable of acquiring the moving image via a storage device or a communication network. Examples of such an electronic apparatus include a personal computer, a tablet computer, a mobile phone apparatus, a smart-phone, a personal digital assistant (PDA), a game machine, a dashboard camera, and a robot, in addition to the digital camera, but are not limited thereto.

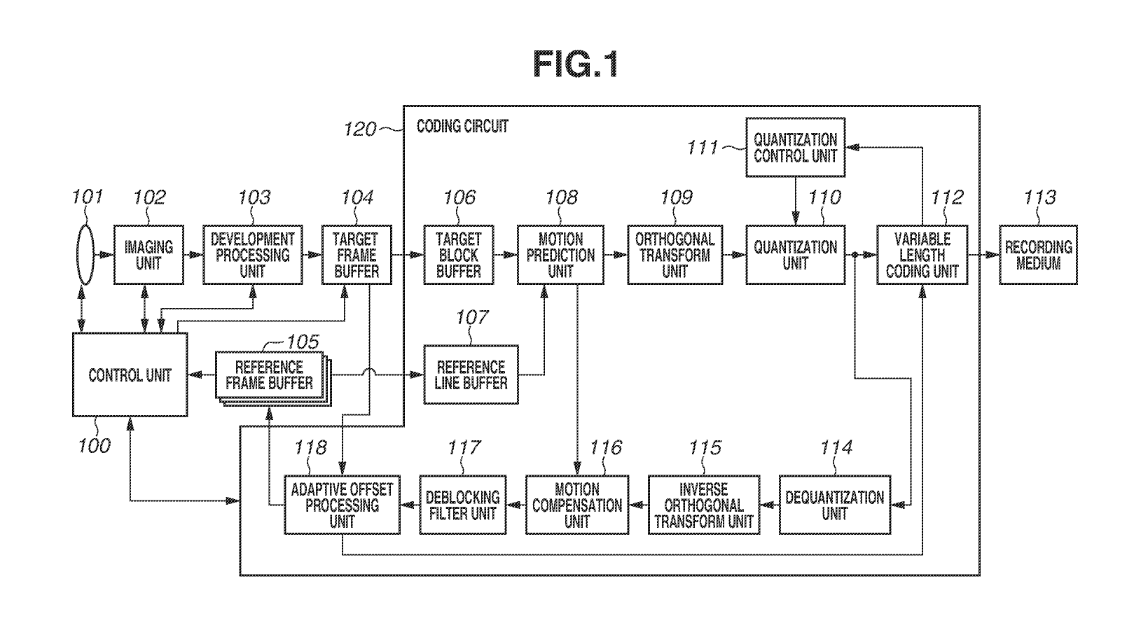

FIG. 1 is a block diagram illustrating an example of a functional configuration of a digital camera to which a motion vector detection apparatus according to a first exemplary embodiment of the present invention is applied. A motion vector is used to code image data in the present exemplary embodiment, so that FIG. 1 illustrates this digital camera focusing on a functional configuration regarding the coding. However, the digital camera according to the present exemplary embodiment also includes configurations provided to a commonly-used digital camera, such as a display unit, an operation unit, and a power source unit regardless of whether they are included in the illustration.

A lens 101 is an imaging optical system that forms an optical image of an object on an imaging plane of an imaging unit 102. The imaging unit 102 photoelectrically converts the optical image formed on the imaging plane by an image sensor including a plurality of pixels, thereby converting it into an electric signal (image signal) indicating an image. Further, the imaging unit 102 converts the image signal from analog data into digital data, and feeds the converted data to a development processing unit 103 as image data. In the present exemplary embodiment, the imaging unit 102 captures the moving image.

The development processing unit 103 applies predetermined image processing, such as noise removal, color interpolation (demosaic), a correction of a defective pixel, a white balance adjustment, a gamma correction, a color tone correction, enlargement/reduction, and a color conversion into YCbCr format, to the image data. The development processing unit 103 can perform various kinds of processing that the commonly-used digital camera performs on the captured image, such as object detection, automatic focus control of the lens 101, and generation of an evaluation value to be used in automatic exposure control, but details thereof will be omitted. The development processing unit 103 feeds image data for recording after the image processing to a coding circuit 120.

A control unit 100 includes, for example, one or more programmable processor(s) (hereinafter simply referred to as a CPU) and memory(ies). A program, various kinds of setting values, graphical user interface (GUI) data, and the like are stored in a nonvolatile memory among the memory(ies). The CPU reads the program into a work area of the memory to execute it to control an operation of each of the units, thereby realizing various kinds of functions of the digital camera.

A target frame buffer 104 temporarily stores data of the image (coding target picture) to be coded by the coding circuit 120, which is output from the development processing unit 103. Assume that an area of a dynamic random access memory (DRAM), which is an external memory of the coding circuit 120, is used as each of the target frame buffer 104 and a reference frame buffer 105 (which will be described below) storing a reference picture therein.

The coding circuit 120 codes the image data for recording according to a predetermined method, thereby generating coded image data having a reduced data amount. In the present exemplary embodiment, the coding circuit 120 is assumed to carry out coding in compliance with the motion compensation inter-frame predictive coding method, such as H.265 or Moving Picture Experts Group-H High Efficiency Video Coding (MPEG-H HEVC) (hereinafter simply referred to as HEVC). The coding circuit 120 is a hardware circuit such as an application specific integrated circuit (ASIC) and a field programmable gate array (FPGA). Then, the coding circuit 120 generates an image file storing the coded image data, and records the generated image file into a recording medium 113, such as a semiconductor memory card.

The coding target picture stored in the target frame buffer 104 is divided in horizontal and vertical directions into blocks, and the control unit 100 stores this coding target picture block by block in a predetermined order into a target block buffer 106, which is a first storage unit. The target block buffer 106 is assumed to be constructed with use of a static random access memory (SRAM), which is an internal memory of the coding circuit 120.

The control unit 100 feeds data of a partial region in the reference picture stored in the reference frame buffer 105 to a reference line buffer 107, which is a second storage unit. As will be described below, the control unit 100 changes a method for managing the reference line buffer 107 according to the number of pixels in the horizontal direction in the coding target picture. The management method herein refers to a logical structure of the reference line buffer 107 (the number of pixels in the horizontal direction and the number of pixels in the vertical direction). The reference line buffer 107 is assumed to be constructed with use of an SRAM, which is an internal memory. As will be described in detail below, the control unit 100 determines a range of data in the reference picture to be fed to the reference frame buffer 105 so as to prevent the same data from being repeatedly read out from reference line buffer 107 as data of a search range to be used in motion vector detection.

A motion prediction unit 108 searches a region of the search range in the reference picture that is stored in the reference line buffer 107 for a region similar to image data of a target block stored in the target block buffer 106. More specifically, the motion prediction unit 108 sets the image data of the target block as a template, causes the template to carry out raster scan pixel by pixel in the search range in the reference picture, calculates a similarity (correlation) between the template and the region in the reference picture at each position, and detects a position where the similarity is maximized in the search range. Then, the motion prediction unit 108 detects, as a motion vector of the template, a vector having an initial point at a position of the template (e.g., coordinates of a center of the template) in the coding target picture and a terminal point at coordinates in the reference picture that corresponds to the position detected in the search range.

The motion prediction unit 108 calculates a difference image (prediction error) between the template and the reference picture at the detected position, and outputs the calculated difference image to an orthogonal transform unit 109. Further, the motion prediction unit 108 outputs the block having the highest similarity in the search range to a motion compensation unit 116 as a predicted image for generation of a locally decoded image.

The orthogonal transform unit 109 generates a transform coefficient by applying an orthogonal transform (e.g., a discrete cosine transform) to the difference image, and outputs the generated transform coefficient to a quantization unit 110.

The quantization unit 110 quantizes the transform coefficient according to a quantization step size (or a quantization parameter) output from a quantization control unit 111. The quantization unit 110 outputs the quantized transform coefficient to a variable length coding unit 112 for generation of a coded stream, and also outputs the quantized transform coefficient to a dequantization unit 114 for the generation of the locally decoded image.

The variable length coding unit 112 carries out, for example, zigzag scan or alternate scan on the quantized transform coefficient, thereby coding the transform coefficient in the variable length coding manner. Further, the variable length coding unit 112 also codes coding information such as the motion vector, the quantization step size, block division information, and a parameter for adaptive offset processing in the variable length coding manner. Then, the variable length coding unit 112 generates the coded stream from the transform coefficient and the coding information coded in the variable length coding manner, and stores the generated coded stream into the recording medium 113. Further, the variable length coding unit 112 calculates a generated code quantity for each of the blocks, and outputs the calculated generated code quantity to the quantization control unit 111.

The quantization control unit 111 determines the quantization step size (or the quantization parameter) from the generated code quantity transmitted from the variable length coding unit 112 and a target code quantity, and outputs the determined quantization step size to the quantization unit 110.

The dequantization unit 114 dequantizes the transform coefficient output from the quantization unit 110, thereby generating a transform coefficient for local decoding. The dequantization unit 114 outputs the generated transform coefficient to an inverse orthogonal transform unit 115.

The inverse orthogonal transform unit 115 generates the difference image by applying an inverse transform (an inverse discrete cosine transform) of the orthogonal transform applied to the transform coefficient by the orthogonal transform unit 109. The inverse orthogonal transform unit 115 outputs the generated difference image to the motion compensation unit 116.

The motion compensation unit 116 generates the image data for the local decoding by adding the predicted image from the motion prediction unit 108 and the difference image from the inverse orthogonal transform unit 115. The motion compensation unit 116 outputs the generated image data to a deblocking filter unit 117.

The deblocking filter unit 117 applies a deblocking filter to the image data, and outputs a result thereof to the adaptive offset processing unit 118. The deblocking filter is a filter for smoothing a discontinuous distortion at a boundary of the target block.

The adaptive offset processing unit 118 categorizes each pixel in the image data after subjecting to the filter processing according to a pixel value and/or a state of an edge, and adds an offset thereto according to the category. The motion vector detection apparatus can also be configured not to add the offset. The deblocking filter unit 117 and the adaptive offset processing unit 118 may also be collectively referred to as an in-loop filter. The adaptive offset processing is processing for eliminating or reducing a false contour (ringing distortion) that occurs near the edge.

The output from the adaptive offset processing unit 118 is stored in the reference frame buffer 105 as the locally decoded image data. Further, the adaptive offset processing unit 118 outputs whether the adaptive offset processing is performed, which category is used, a band position, an edge direction, an offset value, and/or the like to the variable length coding unit 112 to contain them into the coded steam as the parameter(s) for the adaptive offset processing.

The coded stream and the locally decoded image are generated by such operations.

In HEVC, the coding processing including the processing for detecting the motion vector is performed pixel-block by pixel-block called Coding Tree Unit (CTU) in a raster scan order. Further, a concept of tiles into which the coding target picture is divided in CTU unit in the vertical and/or horizontal direction(s) is introduced in HEVC, and each of the tiles can be coded and decoded independently of another tile. In a case where the tiles are set, the coding processing is performed on the CTU in the tile in an order according to the raster scan closed in each of the tiles. Therefore, the order of coding the CTU is different between when the tiles are set and when the tiles are not set.

Next, a method for storing the reference picture in the reference line buffer 107 will be described.

This method will be described supposing that the number of pixels in the coding target picture is 1920×1080, and the motion vector search range is ±512 pixels in the horizontal direction and ±128 lines (pixels) in the vertical direction outside the target block (CTU) by way of example. This means that, if the target block has a size of x pixels in the horizontal direction and y pixels in the vertical direction, a maximum search range is (1024+x) pixels in the horizontal direction and (256+y) pixels in the vertical direction.

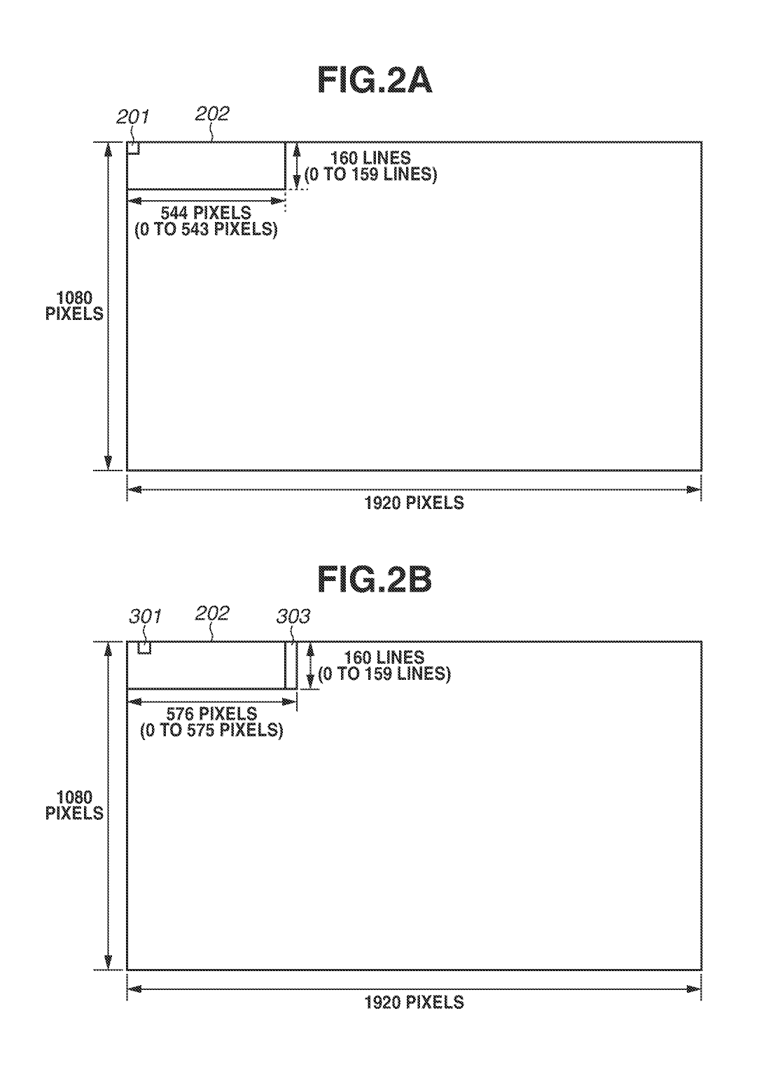

FIG. 2A illustrates examples of the target block (hereinafter referred to as the CTU) and the range of the search for the motion vector. Now, assume that a size of the CTU is 32×32 pixels and an origin is set at an upper left corner in the image. Then, a CTU(X, Y) expresses a CTU having coordinates (X, Y), which are coordinates set CTU by CTU, in an xy coordinate system where a positive side is set to a raster scan direction. Therefore, X and Y can have values in ranges of X=0 to 59 and Y=0 to 33, respectively.

A CTU(0, 0) 201 is a CTU processed first in the coding target picture. The CTU(0, 0) 201 is not subjected to a search above it and a search to the left of it. Therefore, a motion vector search range 202 is set to a rectangular region having diagonal vertices respectively placed at (0, 0) and (543, 159) and extending over 544 (=32+512) pixels in the horizontal direction and 160 (=32+128) pixels in the vertical direction in the reference picture.

The control unit 100 reads out a portion of the search range 202 in the reference picture from the reference frame buffer 105 and stores the read portion into the reference line buffer 107, before the coding of the CTU(0, 0) 201 is started.

FIG. 2B illustrates a CTU(1, 0) 301 to be coded next after the CTU(0, 0) 201. A motion vector search range with respect to the CTU(1, 0) 301 is set to a rectangular region having diagonal vertices respectively placed at (0, 0) and (575, 159) and extending over 576 (=32+32+512) pixels in the horizontal direction and 160 (=32+128) pixels in the vertical direction.

At this time, the search range 202 of the CTU(0, 0) 201 in this search range is already stored in the reference line buffer 107. Therefore, the control unit 100 reads out only a newly required rectangular region 303 having diagonal vertices respectively placed at (544, 0) and (575, 159) from the reference frame buffer 105, and additionally stores the read rectangular region 303 into the reference line buffer 107, before the coding of the CTU(1, 0) 301 is started.

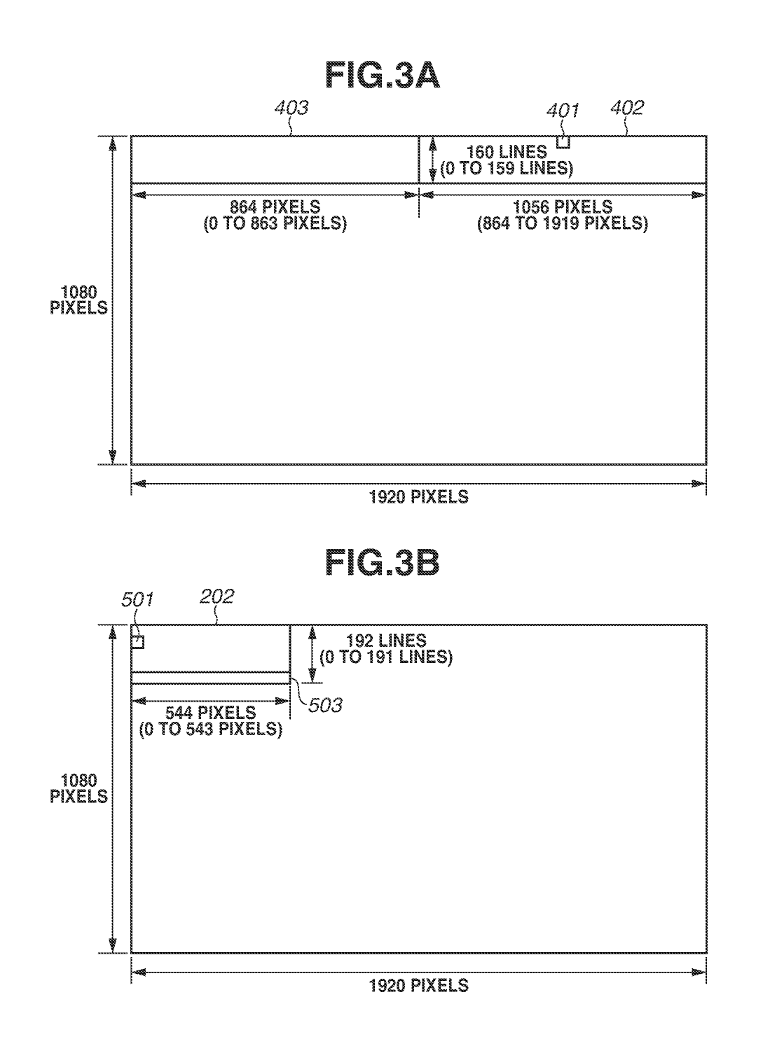

FIG. 3A illustrates a CTU(43, 0) 401. A right edge of a motion vector search range 402 with respect to the CTU(43, 0) 401 coincides with a right edge of the reference picture. The search range 402 is a rectangular region having diagonal vertices respectively placed at (864, 0) and (1919, 159) and extending over 1056 pixels in the horizontal direction and 160 pixels in the vertical direction.

A region 403 in the reference picture that has diagonal vertices respectively placed at (0, 0) and (863, 159), which was previously used as the motion vector search region, is not used in the search for the motion vector with respect to the CTU(43, 0) 401. However, this region 403 contains a range of the search for the motion vector with respect to the next CTU line (CTU(X, 1)), and therefore is held in the reference line buffer 107.

A motion vector search range of a CTU(0, 1) 501, which is illustrated in FIG. 3B, is a rectangular region having diagonal vertices respectively placed at (0, 0) and (543, 191), and the search range 202 of the CTU(0, 0) 201 in this range is already stored in the reference line buffer 107. Therefore, the control unit 100 reads out only a newly required rectangular region 503 having diagonal vertices respectively placed at (0, 160) and (543, 191) from the reference frame buffer 105, and stores the read rectangular region 503 into the reference line buffer 107, before the coding of the CTU(0, 1) 501 is started.

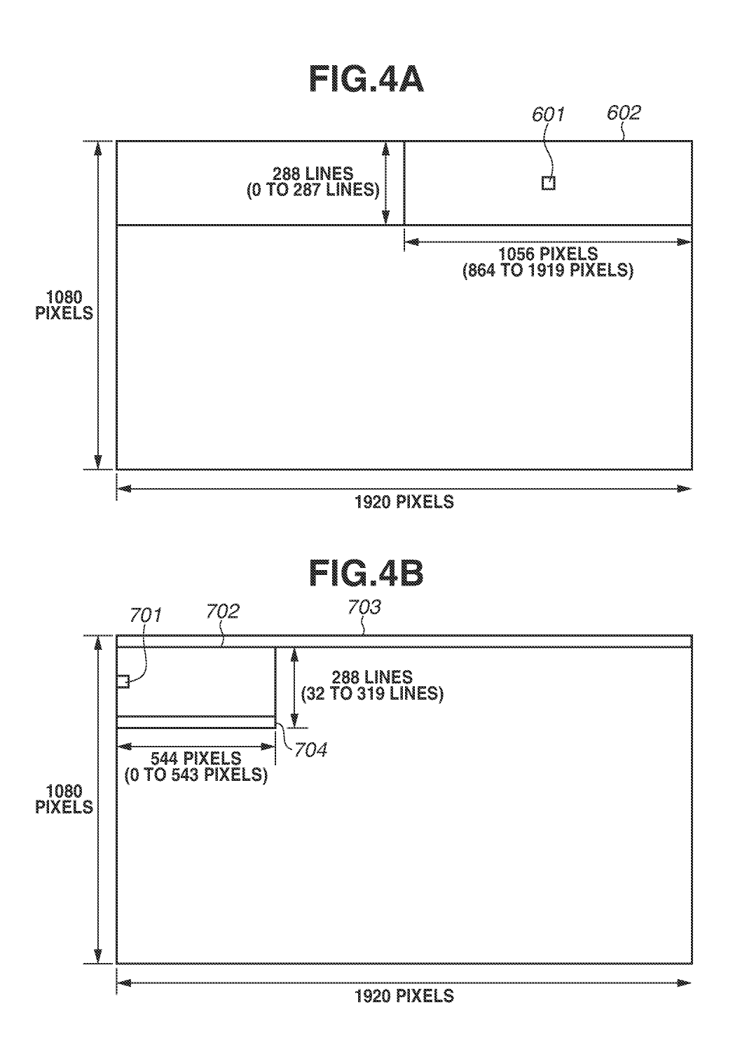

FIG. 4A illustrates a search range 602 largest in size (1056 pixels in the horizontal direction and 288 pixels in the vertical direction), and having an upper edge and a right edge reaching an upper edge and the right edge of the reference picture, respectively. The search range 602 is set with respect to a CTU(43, 4) 601. The search range 602 is a rectangular region having diagonal vertices respectively placed at (864, 0) and (1919, 287).

At this time, a rectangular region having diagonal vertices respectively placed at (0, 0) and (1919, 287) in the reference picture is stored in the reference line buffer 107.

A motion vector search range of a CTU (0, 5) 701, which is illustrated in FIG. 4B, is a rectangular region having diagonal vertices respectively placed at (0, 32) and (543, 319). A range 702 having diagonal vertices respectively placed at (0, 32) and (543, 287) in this range, which overlaps with a search range of a CTU (0, 4), is already stored in the reference line buffer 107. On the other hand, a range 703 containing a range having diagonal vertices respectively placed at (0, 0) and (543, 31), which does not overlap with the search range of the CTU (0, 5) 701, is not used as the search range in the motion vector detection with respect to the CTU (0, 5) 701 and CTUs subsequent thereto. Therefore, the control unit 100 overwrites a part of the region in the reference line buffer 107 that holds the range 703 with a rectangular region 704 newly required as the reference range, and stores this rectangular region 704.

In other words, the control unit 100 reads out only the newly required rectangular region 704 having diagonal vertices respectively placed at (0, 288) and (543, 319) from the reference frame buffer 105, and stores the read rectangular region 704 into the reference line buffer 107, before the coding of the CTU(0, 5) 701 is started.

The reference line buffer 107 is used as a line buffer having a horizontal size equal to the number of pixels in the horizontal direction in the reference picture (1920 pixels in the present example) and a vertical size equal to a sum (288 pixels) of the vertical search range (±128 pixels) and the vertical CTU size (32 pixels).

Then, in a case where the number of pixels in the coding target picture is increased to, for example, 4096 pixels in the horizontal direction×2160 pixels in the vertical direction, the portion read out once is similarly held in the reference line buffer 107 until the use thereof is stopped. In this case, a capacity for storing 4096 pixels in the horizontal direction and 288 lines (pixels) in the vertical direction is required in the reference line buffer 107 unless the range of the search for the motion vector is changed. On the other hand, in a case where the capacity of the reference line buffer 107 cannot be increased, the range of the search for the motion vector should be narrowed, which may deteriorate accuracy of the search for the motion vector.

The number of pixels in the coding target picture is expected to continue increasing in the future, but determining the capacity of the reference line buffer 107 in anticipation thereof results in an increase in a scale of the circuit, thereby causing increases in cost, power consumption, and a mounting area. Further, this approach cannot deal with the coding target picture having the number of pixels that is more than expected.

Therefore, in the present exemplary embodiment, when the number of pixels in the horizontal direction in the coding target picture is a threshold value or larger, the control unit 100 (logically) divides the coding target picture in the horizontal direction, and changes the order of detecting the motion vector in such a manner that the motion vector is detected with respect to each block divided-region by divided-region. For example, for the detection of the motion vector in HEVC, the control unit 100 changes the order of detecting the motion vector in such a manner that the motion vector is detected tile by tile, by setting a plurality of tiles into which the coding target picture is divided in the horizontal direction.

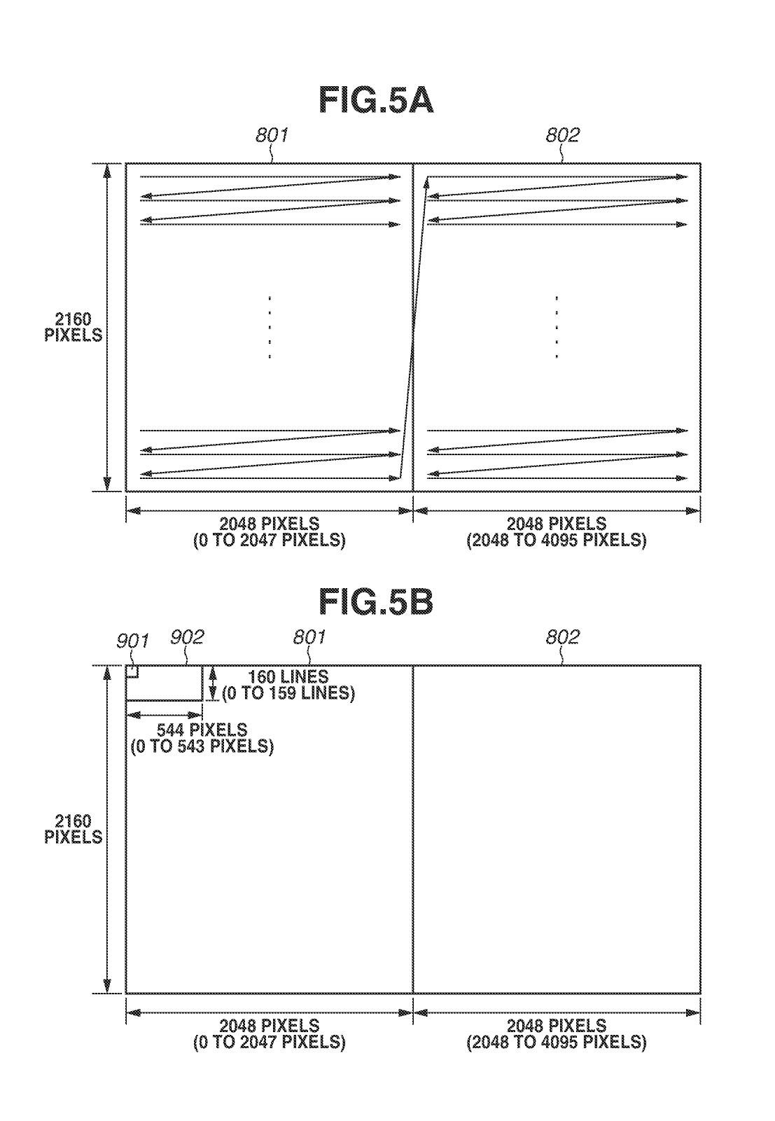

In a case where the threshold value is, for example, 2048 and the number of pixels in the coding target picture is, for example, 4096 pixels in the horizontal direction×2160 pixels in the vertical direction, the control unit 100 sets tiles as illustrated in FIG. 5A.

In this example, the control unit 100 sets a tile 801 and a tile 802 generated by dividing the coding target picture into two rectangles in a grid-like manner. A direction in which the image is divided in the present exemplary embodiment refers to a direction perpendicular to a division line. Therefore, in a case where the division line (a boundary line between the tiles) is a vertical straight line as illustrated in FIG. 5A, this division manner is described as dividing the coding target picture in the horizontal direction. The tile 801 is a rectangular region having diagonal vertices respectively placed at (0, 0) and (2047, 2159) and extending over 2048 pixels in the horizontal direction. Further, the tile 802 is a rectangular region having diagonal vertices respectively placed at (2048, 0) and (4095, 2159) and extending over 2048 pixels in the horizontal direction.

In a case where the tiles are set in HEVC, the coding processing (detection of the motion vector) is performed in the raster scan order for each of the tiles as illustrated in FIG. 5A with respect to the target block (CTU) in the tile. More specifically, the processing for detecting the motion vector is performed with respect to a block contained in the tile among a plurality of target blocks located in the same block row in the coding target picture, and then the processing for detecting the motion vector is performed with respect to a block contained in the tile among a plurality of target blocks located in the next block row. Therefore, the order of the raster scan (or a length of one scan line), which determines the order among the blocks with respect to which the motion vector is detected, is changed by setting the tiles in the coding target picture. The coding processing in the tile 801 and the coding processing in the tile 802 may be performed in parallel with each other, but, in the present exemplary embodiment, the coding processing is assumed to be also performed in the raster scan order in terms of the tiles. Therefore, the coding processing is first performed with respect to all of CTUs contained in the tile 801, and, after that, the coding processing is performed with respect to CTUs contained in the tile 802.

The control unit 100 changes the order among the blocks with respect to which the processing for detecting the motion vector is performed, and also changes the method for managing the reference line buffer 107 (the logical configuration of the reference line buffer 107). Before the change, the control unit 100 controls the reading and writing from and into the reference line buffer 107, assuming that there are as many line buffers each having a horizontal size equal to the number of pixels in the horizontal direction in the coding target picture as the number of lines equal to (the vertical (top-to-bottom) search range+the vertical CTU size).

On the other hand, after the change, the control unit 100 controls the reading and writing from and into the reference line buffer 107, assuming that there are as many line buffers each having a horizontal size of (a horizontal tile size+the horizontal search range in one direction) as the number of lines equal to (the vertical (top-to-bottom) search range+the vertical CTU size). The vertical size of the reference line buffer 107 is unchanged.

The control unit 100 can detect the number of pixels in the horizontal direction in the coding target picture based on, for example, a setting of the imaging unit 102, and determine how to set the tiles based on a pre-stored relationship between the number of pixels in the horizontal direction, and whether to set the tiles and/or the sizes of the tiles. Further, in the present exemplary embodiment, the tiles have been described referring to the tiles into which the coding target picture is divided only in the horizontal direction, but the tiles can also be set in such a manner that the coding target picture is divided in both the vertical direction and the horizontal direction. The relationship between the number of pixels in the horizontal direction in the coding target picture and the sizes of the tiles (or the number of tiles into which the coding target picture is divided in each direction) can be predetermined based on the capacity of the reference line buffer 107, the size of the search range, and the number of pixels in the horizontal direction in the coding target picture.

The control unit 100 notifies the coding circuit 120 of the sizes of the tiles to be set (or the number of tiles into which the coding target picture is divided in each direction) if determining that the tiles should be set. Further, the control unit 100 changes an order of reading out the block to be stored from the target frame buffer 104 into the target block buffer 106 so that the coding processing is performed set-tile by set-tile. Further, the control unit 100 also changes the range of the reference picture to be stored from the reference frame buffer 105 into the reference line buffer 107 in correspondence with the order among the target blocks to be subjected to the processing for detecting the motion vector.

The motion prediction unit 108 reads out the search range determined from a number of the target block stored in the target block buffer 106 or the position (X, Y) thereof in a reference picture from the reference line buffer 107, and detects the motion vector. At this time, the motion prediction unit 108 determines a relationship between an address in the reference line buffer 107 and the stored position in the reference picture based on information about the set tiles, and reads out the image data of the search range. In other words, the motion prediction unit 108 changes the method for managing the reference line buffer 107 according to the setting of the tiles.

FIG. 5B illustrates the CTU (target block) targeted for the coding processing (motion vector detection) and the range of the search for the motion vector when the tiles 801 and 802 illustrated in FIG. 5A are set. FIG. 5B illustrates a CTU (0, 0) 901, which is the first CTU in the raster scan order among the CTUs in the tile 801, and a motion vector search range 902 thereof. The search range 902 is a rectangular region having diagonal vertices respectively placed at (0, 0) and (543, 159) and extending over 544 (=32+512) pixels in the horizontal direction and 160 (=32+128) pixels in the vertical direction, and is similar to when the tiles are not set.

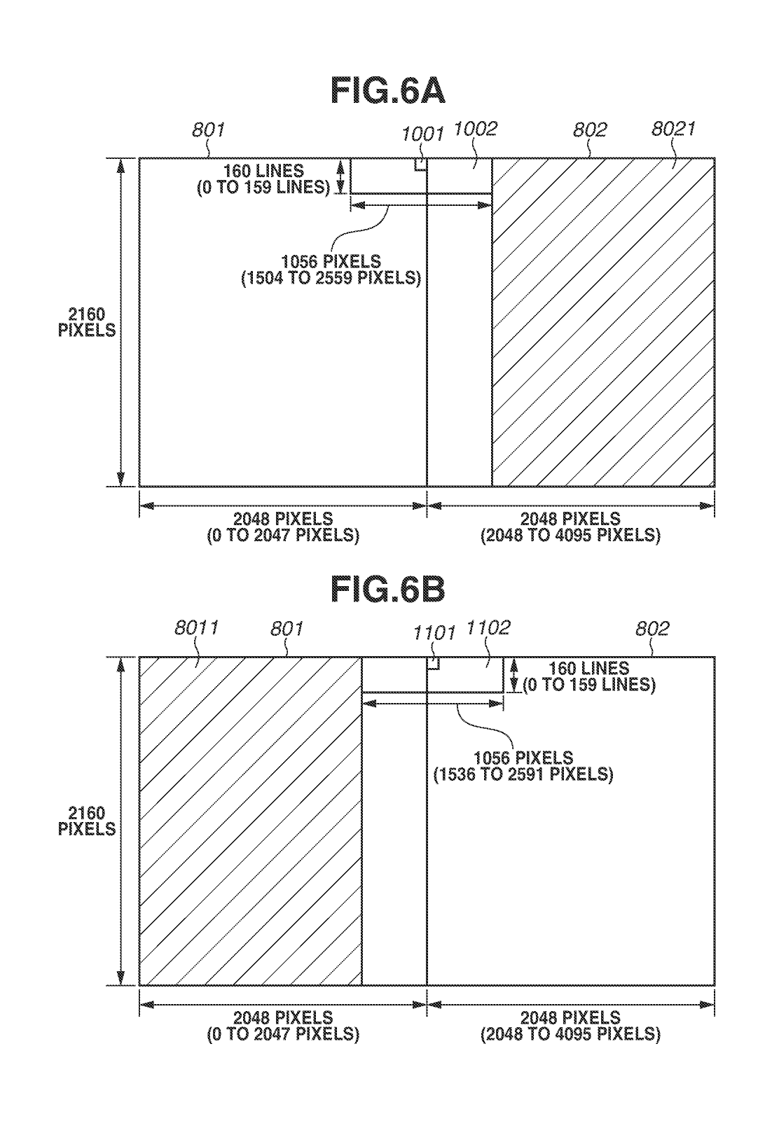

FIG. 6A illustrates a CTU (63, 0) 1001, which first reaches a right edge of the tile 801 in the raster scan order among the CTUs in the tile 801, and a motion vector search range 1002 of the CTU (63, 0) 1001. The search range 1002 is a rectangular region having diagonal vertices respectively placed at (1504, 0) and (2559, 159) and extending over 1056 (=512+32+512) pixels in the horizontal direction and 160 (=32+128) pixels in the vertical direction.

The CTU (63, 0) 1001 is located at the right edge of the tile 801. Therefore, a range having a larger X coordinate value than the search range 1002 (a region 8021 having diagonal vertices respectively placed at (2560, 0) and (4095, 2159)) in the reference picture is not used in the motion vector detection with respect to the CTUs in the tile 801.

After the coding of all of the CTUs in the tile 801 is ended, the coding processing is performed with respect to the CTUs in the tile 802 in a similar manner. FIG. 6B illustrates a CTU (0, 0) 1101, which is the first CTU in the raster scan order among the CTUs in the tile 802, and a motion vector search range 1102 thereof. The search range 1102 is a rectangular region having diagonal vertices respectively placed at (1536, 0) and (2591, 159) and extending over 1056 (=512+32+512) pixels in the horizontal direction and 160 (=32+128) pixels in the vertical direction.

The CTU (0, 0) 1101 is located at a left edge of the tile 802. Therefore, a range having a smaller X coordinate value than the search range 1102 (a region 8011 having diagonal vertices respectively placed at (0, 0) and (1535, 2159)) in the reference picture is not used in the motion vector detection with respect to the CTUs in the tile 802, and therefore does not have to be kept stored in the reference line buffer 107. Therefore, image data of the region 8011 is deleted from the reference line buffer 107 or overwritten with image data of another region when becoming unnecessary.

In this manner, the present exemplary embodiment can reduce the number of pixels in the horizontal direction in the reference line buffer 107 that is required for the target pixels as many as 4096 pixels as the number of pixels in the horizontal direction, to 2560 pixels by setting the tiles 801 and 802. Further, a capacity for 288 pixels (lines) at most is required regarding the vertical direction in the case where the search range is set to 128 pixels in each direction (above and below the CTU), supposing that the vertical size of the CTU is 32 pixels. Therefore, by setting the tiles 801 and 802, the present exemplary embodiment allows the motion vector to be detected without requiring the same region in the reference picture to be repeatedly read out from the reference frame buffer 105 with respect to the coding target picture having the size of 4096 pixels as the number of pixels in the horizontal direction×2160 pixels as the number of pixels in the vertical direction, as long as a capacity of 2560 pixels in the horizontal direction×288 pixels in the vertical direction is available in the reference line buffer 107.

When the tiles are not set, the reference line buffer 107 should have the capacity of 4096 pixels in the horizontal direction×288 pixels in the vertical direction to allow the motion vector to be detected without requiring the same region in the reference picture to be repeatedly read out (as described with reference to FIGS. 2A and 2B to 4A and 4B). On the other hand, when the tiles 801 and 802 are set, the reference line buffer 107 only has to have the capacity of 2560 pixels in the horizontal direction×288 pixels in the vertical direction, and therefore can save 37.5% of the capacity.

Supposing that the vertical size of the search range is m pixels (128×2+32 pixels in the present example) and the capacity of the reference line buffer 107 is T pixels, a maximum number n of pixels in the horizontal direction that can be read in is floor(T/m) (floor(x) represents a maximum integer that is x or smaller). In this case, supposing that the size of the search range in one direction (a right-side direction or a left-side direction) along the horizontal direction is o (512 pixels in the present example), setting the tiles so as to satisfy the horizontal size of each of the tiles≦(n−o) allows the motion vector to be efficiently detected with respect to an input image (the coding target picture) having a further larger number of pixels in the horizontal direction without reducing the vertical size of the search range.

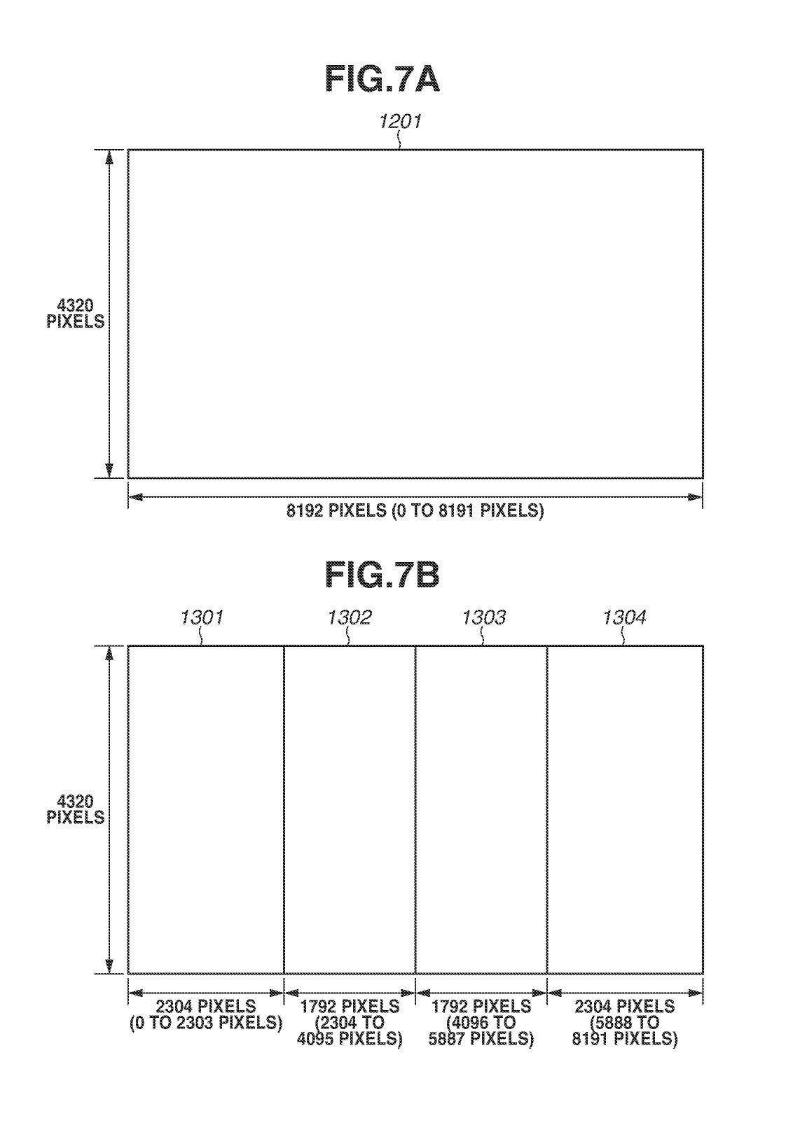

The present example has been described assuming that two tiles are set (the number of tiles into which the coding target picture is divided in the horizontal direction is two), but the number of tiles can also be further increased. For example, suppose that the number of pixels in the horizontal direction in the coding target picture is increased to 8192 pixels (second value) more than 4096 pixels (a first value) as illustrated in FIG. 7A. In this case, even if the coding target picture is divided into two tiles in the horizontal direction, the number of pixels in the horizontal direction in each of the tiles is 4096 pixels. Increasing the number of tiles (the number of tiles into which the coding target picture is divided in the horizontal direction), for example, as illustrated in FIG. 7B allows the motion vector to be detected without requiring the same region in the reference picture to be repeatedly read out from the reference frame buffer 105 with use of the reference line buffer 107 having a similar capacity to when the number of pixels in the horizontal direction in the coding target picture is 4096 pixels.

As described above, the relationship between the number of pixels in the horizontal direction in the coding target picture and the sizes of the set tiles (or the number of tiles into which the coding target picture is divided in each direction) can be determined in advance based on the capacity of the reference line buffer 107, the size of the search range, and the number of pixels in the horizontal direction in the coding target picture. Therefore, the control unit 100 can set appropriate tiles (appropriately write the data into the target block buffer 106 and the reference line buffer 107) according to the number of pixels in the horizontal direction in the coding target picture.

In the example illustrated in FIG. 7B, four tiles 1301 to 1304 are set, but the tiles 1302 and 1303 located in the middle are smaller in horizontal size than the tiles 1301 and 1304 located at both the edges. This is because a search range containing a range outside the tile is used at both a right edge and a left edge of the tile for the tiles 1302 and 1303 located in the middle.

For the tile 1301, a search range of 512 pixels at most outward from a right edge thereof is set in addition to 2304 pixels that is the number of pixels in the horizontal direction in the tile 1301. Therefore, the capacity of the reference line buffer 107 should be managed based on the number of pixels in the horizontal direction as many as 2304+512=2816 pixels to allow the motion vector to be detected without requiring the same region in the reference picture to be repeatedly read out from the reference frame buffer 105. For the tile 1304, a search range of 512 pixels at most outward from a left edge thereof is also set in addition to 2304 pixels that is the number of pixels in the horizontal direction in the tile 1304, so that the capacity of the reference line buffer 107 should be similarly managed based on the number of pixels in the horizontal direction as many as 2816 pixels.

On the other hand, for each of the tiles 1302 and 1303 located in the middle, a search range of 512 pixels at most outward from the right edge thereof and a search range of 512 pixels at most outward from the left edge thereof are set in addition to 1792 pixels that is the number of pixels in the horizontal direction therein. Therefore, the capacity of the reference line buffer 107 should be managed based on the number of pixels as many as 512+1792+512=2816 pixels to allow the motion vector to be detected without requiring the same region in the reference picture to be repeatedly read out into the reference line buffer 107.

For example, supposing that the number of pixels in the horizontal direction in the coding target picture is d pixels, the number of tiles into which the coding target picture is divided in the horizontal direction is h, and the size of the search range in one direction (right-side direction or the left-side direction) along the horizontal direction is o, the capacity of the reference line buffer 107 can be managed based on the equal number of pixels in the horizontal direction with respect to each of the tiles by dividing the coding target picture so as to satisfy relationships of the horizontal size of each of the tiles located at the right edge and the left edge=(d−2×o)/h+o, and the horizontal size of each of the other tiles (located in the middle)=(d−2×o)/h.

Even in this case, the motion vector can be efficiently detected with respect to the input image (coding target picture) having the further larger number of pixels in the horizontal direction without a reduction in the search size in the vertical direction, by determining the number h of tiles into which the coding target picture is divided so as to satisfy the horizontal size of each of the tiles located at the right edge and the left edge+o≦n and the horizontal size of each of the other tiles (located in the middle)+(2×o)≦n.

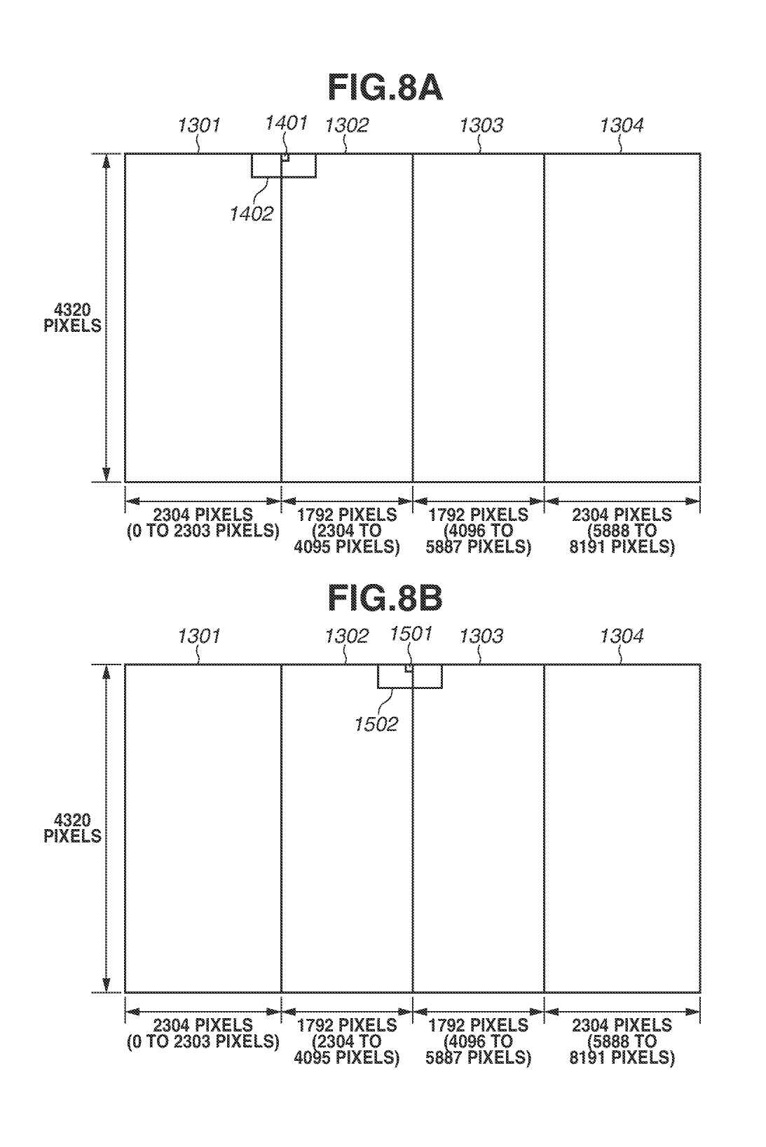

FIG. 8A illustrates a CTU (72, 0) 1401 with respect to which the motion vector is detected first in the tile 1302 located in the middle, and a motion vector search range 1402 thereof. The search range 1402 is a rectangular region having diagonal vertices respectively placed at (1792, 0) and (2847, 159).

When the motion vector is detected with respect to the CTU in the tile 1302, coordinates of a left edge of the reference picture stored in the reference line buffer 107 are (1792, y). These coordinates are offset to the left from coordinates (2304, y) of the left edge of the tile 1302 by an amount corresponding to the search range (512 pixels) on the left side in the horizontal direction.

FIG. 8B illustrates a CTU (127, 0) 1501 with respect to which the motion vector is detected first among CTUs located at the right edge of the tile 1302 located in the middle, and a motion vector search range 1502 thereof. The search range 1502 is a rectangular region having diagonal vertices respectively placed at (3552, 0) and (4607, 159).

When the motion vector is detected with respect to the CTU in the tile 1302, coordinates of a right edge of the reference picture stored in the reference line buffer 107 are (4607, y). These coordinates are offset to the right from coordinates (4095, y) of the right edge of the tile 1302 by an amount corresponding to the search range (512 pixels) on the right side in the horizontal direction.

For all of the CTUs in the tiles 1302 and 1303 located in the middle, the search ranges are set on both the left and right sides of each of them. Therefore, the capacity of the reference line buffer 107 should be managed based on the number of pixels in the horizontal direction as many as (the horizontal tile size+the horizontal search range in one direction×2) to allow the motion vector to be detected without requiring the same region in the reference picture to be repeatedly read out from the reference frame buffer 105.

The example described here allows the motion vector to be detected without requiring the same region in the reference picture to be repeatedly read out into the reference line buffer 107 by managing the capacity of the reference line buffer 107 based on the number of pixels in the horizontal direction as many as 2816 pixels for both the tiles 1301 and 1304 located at both the left and right edges and the tiles 1302 and 1303 located in the middle. Therefore, if the vertical size of the search range (288 pixels) is unchanged, this example allows the motion vector to be detected without requiring the same region in the reference picture to be repeatedly read out from the reference frame buffer 105 with use of the reference line buffer 107 having the smaller capacity than when the tiles are not set by approximately 65% (2816/8192=0.34).

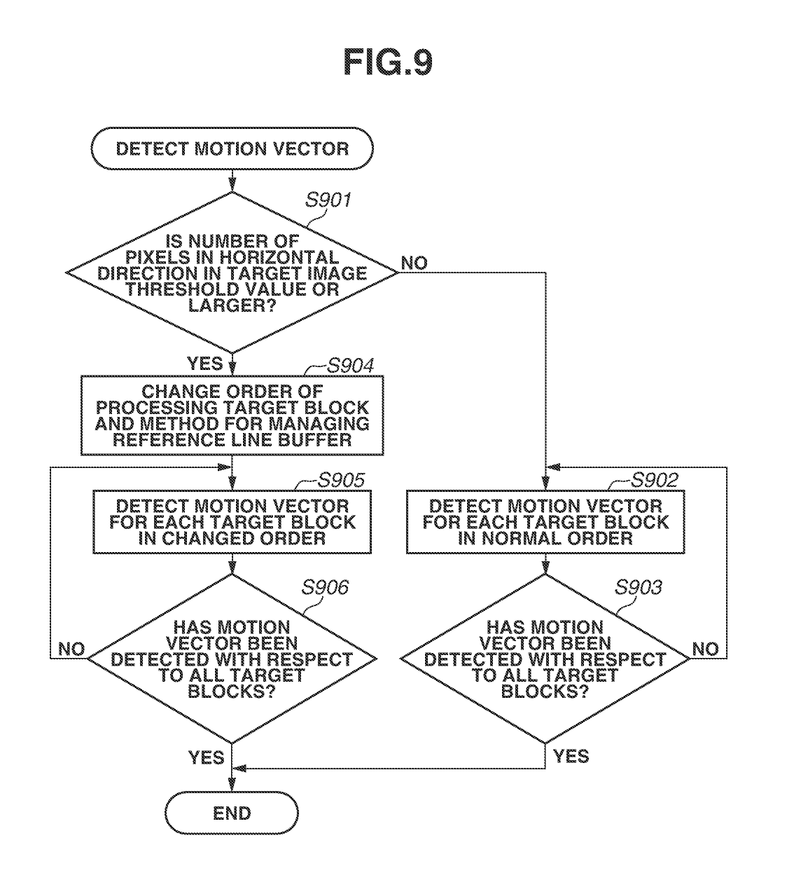

FIG. 9 is a flowchart illustrating the operation of detecting the motion vector according to the present exemplary embodiment.

In step S901, the control unit 100 acquires the number of pixels in the horizontal direction in the frame of the moving image targeted for the detection of the motion vector from, for example, the setting of the imaging unit 102. Then, the control unit 100 compares the number of pixels in the horizontal direction in the moving image and the predetermined threshold value. If the number of pixels in the horizontal direction is determined to be the threshold value or larger (YES in step S901), the processing proceeds to step S904. If the number of pixels in the horizontal direction is not determined to be the threshold value or larger (NO in step S901), the processing proceeds to step S902.

In step S902, the control unit 100 and the coding circuit 120 detect the motion vector in a normal order with respect to the plurality of blocks (the target blocks) into which the frame image targeted for the coding (the coding target picture) is divided. The normal order is the raster scan order with the entire coding target picture handled as one region. At this time, the control unit 100 and the coding circuit 120 manage the reference line buffer 107 as being formed by the line buffer having the equal number of pixels in the horizontal direction to the number of pixels in the horizontal direction in the coding target picture as described with reference to FIGS. 2A and 2B and 3A and 3B, read out a part of the reference picture from the reference frame buffer 105 to write it into the reference line buffer 107, and detect the motion vector. By this operation, the control unit 100 and the coding circuit 120 efficiently detect the motion vector without repeatedly reading out the same region in the reference picture from the reference frame buffer 105.

The control unit 100 and the coding circuit 120 repeatedly perform the processing in step S902 until the control unit 100 determines that the motion vector has been detected with respect to all of the target blocks in the coding target picture in step S903. If the control unit 100 determines that the motion vector has been detected with respect to all of the target blocks in the coding target picture in step S903 (YES in step S903), the processing for detecting the motion vector with respect to the coding target picture is ended. After that, the control unit 100 and the coding circuit 120 repeat similar processing, targeting the next frame image as the coding target picture.

On the other hand, in step S904, the control unit 100 changes the order of processing the target block and the method for managing the capacity of the reference line buffer 107 according to the number of pixels in the horizontal direction in the moving image. As described above, the control unit 100 changes the order of processing the target block by, for example, setting the plurality of logical regions (e.g., the tiles in HEVC) into which the coding target picture is divided in the horizontal direction. Changing the order of processing the target block is equivalent to changing the processing order so as to detect the motion vector independently with respect to each of the plurality of logical regions into which the coding target picture is divided in the horizontal direction. Alternatively, changing the order of processing the target block can also be regarded as reducing the length of one scan line in the raster scan, which determines the order among the target blocks.

Further, the control unit 100 changes the reference line buffer 107 so as to manage it as being formed by the line buffer having a smaller number of pixels in the horizontal direction than the number of pixels in the horizontal direction in the coding target picture. The number of pixels in the horizontal direction in the line buffer is determined depending on the horizontal sizes of the logical regions and the horizontal size of the search range. The number of logical regions to be set and the method for managing the reference line buffer 107 can be stored in advance in association with the number of pixels in the horizontal direction in the moving image.

In step S905, the control unit 100 and the coding circuit 120 detect the motion vector in the order after the change with respect to the plurality of blocks (target blocks) into which the frame image targeted for the coding (coding target picture) is divided. The order after the change is the raster scan order for each of the regions into which the coding target picture is divided in the horizontal direction.

The control unit 100 and the coding circuit 120 repeatedly perform the processing in step S905 until the control unit 100 determines that the motion vector has been detected with respect to all of the target blocks in the coding target picture in step S906. If the control unit 100 determines that the motion vector has been detected with respect to all of the target blocks in the coding target picture in step S906 (YES in step S906), the processing for detecting the motion vector with respect to the coding target picture is ended. After that, the control unit 100 and the coding circuit 120 repeat similar processing, targeting the next frame image as the coding target picture.

As described above, according to the present exemplary embodiment, the motion vector detection apparatus is configured to detect the motion vector with respect to each of the blocks region by region based on the regions into which the coding target picture is divided in the horizontal direction if the number of pixels in the horizontal direction in the coding target picture is larger than or equal to the threshold value when detecting the motion vector block by block based on the blocks in the coding target picture. Alternatively, the motion vector detection apparatus changes the order of the raster scan, which determines the order among the blocks with respect to which the motion vector is detected, so as to process only a part of the target blocks contained in the horizontal block row and then shift to the processing of the target blocks contained in the next block row (or is configured to reduce the length of one scan line) if the number of pixels in the horizontal direction in the coding target picture is larger than the threshold value. Therefore, the motion vector detection apparatus can detect the motion vector without increasing the capacity of the buffer for holding the image of the range of the search for the motion vector in the reference picture according to the increase in the number of pixels in the horizontal direction in the coding target picture, and without narrowing the search range.

In the present example, the configuration using the tiles in HEVC has been described as an example of making the change so as to detect the motion vector independently for each partial region in the coding target picture. However, the applicability of the method for detecting the motion vector that has been described in the present exemplary embodiment is not limited to the detection of the motion vector that is used in the coding, and this method can also be applied to the detection of the motion vector for any use or purpose.

In the above-described exemplary embodiment, the size of the search range is constant (±512 pixels in the horizontal direction and ±128 pixels in the vertical direction) regardless of whether the tiles are set. However, the motion vector detection apparatus can also set a narrower horizontal search range when setting the tiles than when not setting the tiles in a case where the capacity of the reference line buffer 107 should be reduced. This is because narrowing the horizontal search range is less influential on the accuracy of the motion vector detection than narrowing the vertical search range, since the horizontal search range is set to a wider range than the vertical search range in the first place.

Further, in the above-described exemplary embodiment, the control unit 100 of the digital camera determines whether the tiles should be set and the sizes of the tiles. However, the motion vector detection apparatus may be configured in such a manner that another control unit (a coding control unit) is prepared in the coding circuit 120 and the coding control unit performs the control regarding the coding processing. In this case, the control unit 100 notifies the coding control unit of only information of the number of pixels in the coding target picture. Then, the coding control unit determines whether the tiles should be set, the sizes of the tiles, and the like. Further, the coding control unit also controls the read-in of the data from the target frame buffer 104 to the target block buffer 106 and the read-in of the data from the reference frame buffer 105 to the reference line buffer 107 according to whether the tiles are set.

The present exemplary embodiment can also be realized by processing of supplying a program capable of realizing one or more function(s) of the above-described exemplary embodiment to a system or an apparatus via a network or a storage medium, and causing one or more processor(s) in a computer of this system or apparatus to read out and execute the program. Further, the present exemplary embodiment can also be realized by a circuit (e.g., an ASIC) capable of realizing one or more function(s).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-163037, filed Aug. 23, 2016, which is hereby incorporated by reference herein in its entirety.

What is claimed is:

1. A motion vector detection apparatus comprising:
a first storage unit configured to store data of a target block with respect to which a motion vector is detected among a plurality of blocks contained in a coding target picture;
a second storage unit configured to store data of a search range for searching for a region in a reference picture to be used to detect the motion vector with respect to the target block;
a detection unit configured to detect the motion vector of the target block based on the region similar to the target block that is searched for in the data of the search range; and
a control unit configured to perform control so as to store data of a first search range in the second storage unit in such a manner that the motion vector with respect to the target block that is contained in the region is detected in a predetermined order while the coding target picture is handled as one region if the number of pixels in a horizontal direction in the coding target picture is smaller than a predetermined value, and store data of a second search range in the second storage unit in such a manner that the motion vector with respect to the target block that is contained in the region is detected in the predetermined order separately for each of a plurality of regions having a smaller number of pixels in the horizontal direction than the number of pixels in the horizontal direction in the coding target picture if the number of pixels in the horizontal direction in the coding target picture is larger than the predetermined value.

2. The apparatus according to claim 1, wherein each of the regions having the smaller number of pixels in the horizontal direction than the number of pixels in the horizontal direction in the coding target picture is a rectangle containing a plurality of target blocks and generated by dividing the coding target picture in a grid-like manner.

3. The apparatus according to claim 1, wherein the number of regions having the smaller number of pixels in the horizontal direction than the number of pixels in the horizontal direction in the coding target picture is increased as the number of pixels in the horizontal direction in the coding target picture is increased.

4. The apparatus according to claim 1, wherein the data of the first search range and the data of the second search range have vertical sizes equal to each other.

5. The apparatus according to claim 1, wherein the predetermined order is a raster scan order.

6. The apparatus according to claim 1, wherein the second storage unit reads out the data of the search range in the reference picture stored in a dynamic random access memory (DRAM) from the DRAM, and writes the read data into a static random access memory (SRAM).

7. The apparatus according to claim 1, wherein the detected motion vector is used in motion compensation inter-frame predictive coding in compliance with High Efficiency Video Coding (HEVC).

8. A method for controlling a motion vector detection apparatus, the method comprising:
storing data of a target block with respect to which a motion vector is detected among a plurality of blocks contained in a coding target picture;
storing data of a search range for searching for a region in a reference picture to be used to detect the motion vector with respect to the target block;
detecting the motion vector of the target block based on the region similar to the target block that is searched for in the data of the search range;
storing data of a first search range in the second storage unit in such a manner that the motion vector with respect to the target block that is contained in the region is detected in a predetermined order while the coding target picture is handled as one region if the number of pixels in a horizontal direction in the coding target picture is smaller than a predetermined value; and
storing data of a second search range in the second storage unit in such a manner that the motion vector with respect to the target block that is contained in the region is detected in the predetermined order separately for each of a plurality of regions having a smaller number of pixels in the horizontal direction than the number of pixels in the horizontal direction in the coding target picture if the number of pixels in the horizontal direction in the coding target picture is larger than the predetermined value.
